(19) United States
(12) Patent Application Publication
(10) Pub. No.: US 2014/0130406 A1
(43) Pub. Date: May 15, 2014

(54) Shading device for potted plants

(71) Applicant: Debra Lynne Burrowes, Belleville (CA)

(72) Inventor: Debra Lynne Burrowes, Belleville (CA)

(21) Appl. No.: 13/676,072

(22) Filed: Nov. 13, 2012

(51) Int. Cl. A01G 13/02

(52) U.S. Cl. 47/20.1

(57) ABSTRACT

A shading device for potted plants has a plurality of stakes planted in the soil of a flower pot. The stakes can be telescoping in nature so as to be adjustable lengthwise. A piece of shading material preferably made of canvas is stretched across the stakes by way of grommets.

This application claims priority based on request GB1120786.7 filed Dec. 3, 2011

### FIELD OF THE INVENTION

The present invention relates generally to but more particularly to potted plants but more particularly to a shading device for potted plants.

### BACKGROUND OF THE INVENTION

Usually, we want plants to receive sunshine and rain but at times, the sun is too intense for some types of plants and they require more shade. There does not exist a convenient way to provide shades to plants.

### SUMMARY OF THE INVENTION

In view of the foregoing disadvantages inherent in the known devices now present in the prior art, the present invention, which will be described subsequently in greater detail, is to provide objects and advantages which are:

To provide for an easy to assemble and install shading device for potted plants.

In order to do so, the invention consists of a shading device for potted plants comprising a plurality of hollow stake members adapted to be securely planted within soil of a potted plant, each of the stake member having a pointed end portion adapted to pierce through the soil, and a hollow end portion opposite the pointed end portion. A piece of shading material having a plurality of grommets therein, and each adapted to receive a respective hollow end portion of respective stake members. A plurality of pin members each adapted to extend through a respective grommet and into the hollow end portion of a respective stake member, such that the shading material is securely attached to the end portions of the plurality of stake members and adapted to be placed above a potted plant.

The shading device has the top portion diameter of the snap fasteners larger than an inner diameter of the grommets, and a main portion diameter that is smaller than an inner diameter of the hollow end portions of the plurality of stake members, such that the pin members are adapted to be frictionally secured within the hollow end portion of each respective stake member, and releasably hold the shading material to each respective hollow end portion of each respective stake member.

In one embodiment, each the plurality of stake members are formed from two telescoping portions, such that each of the plurality of stake members are adjustable in length, and wherein each the plurality of stake members includes a tightening bolt adapted to securely hold each respective telescoping portion in position to one another at respective desired lengths.

Each the plurality of stake members include an attachment member adapted to attach to a pot member of a potted plant, to thereby offer a secure position between the shade member and a potted plant. Each the attachment member is formed as a resilient string member.

In a preferred embodiment, the shading material is formed from a canvas material.

In yet another embodiment, there are three stake members, and there are three grommets within the shading material and the shading material is formed in the shape of a triangle.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1a-b Isometric views of the invention in context, without and with the canvas, respectively.

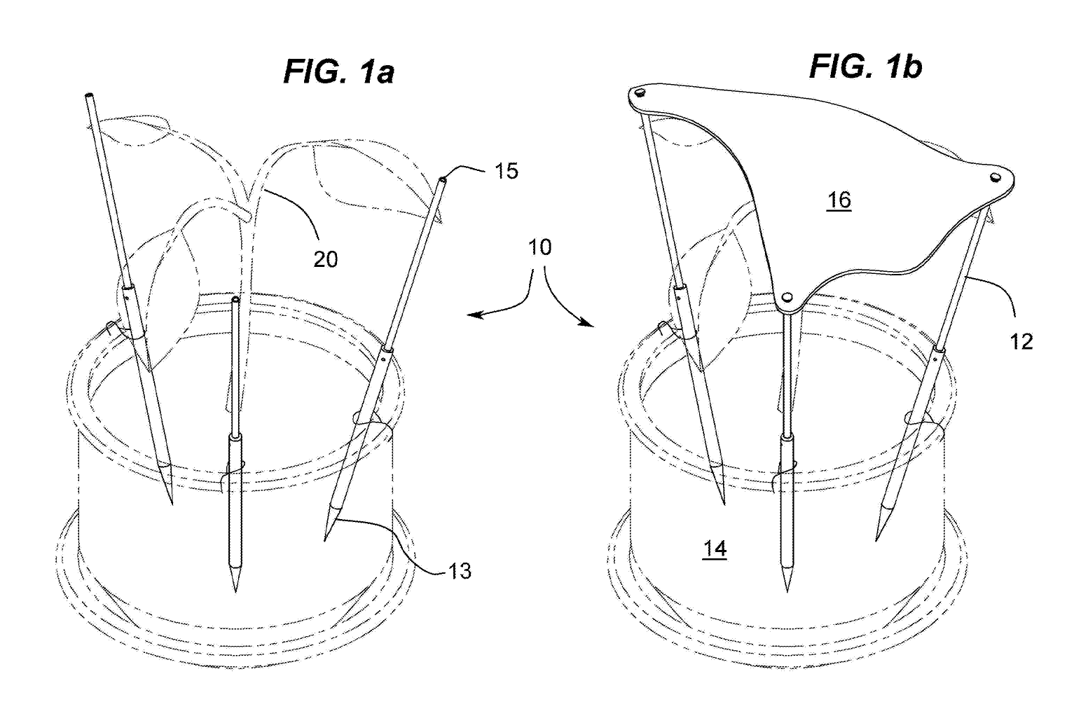

FIG. 2 Exploded view of the invention.

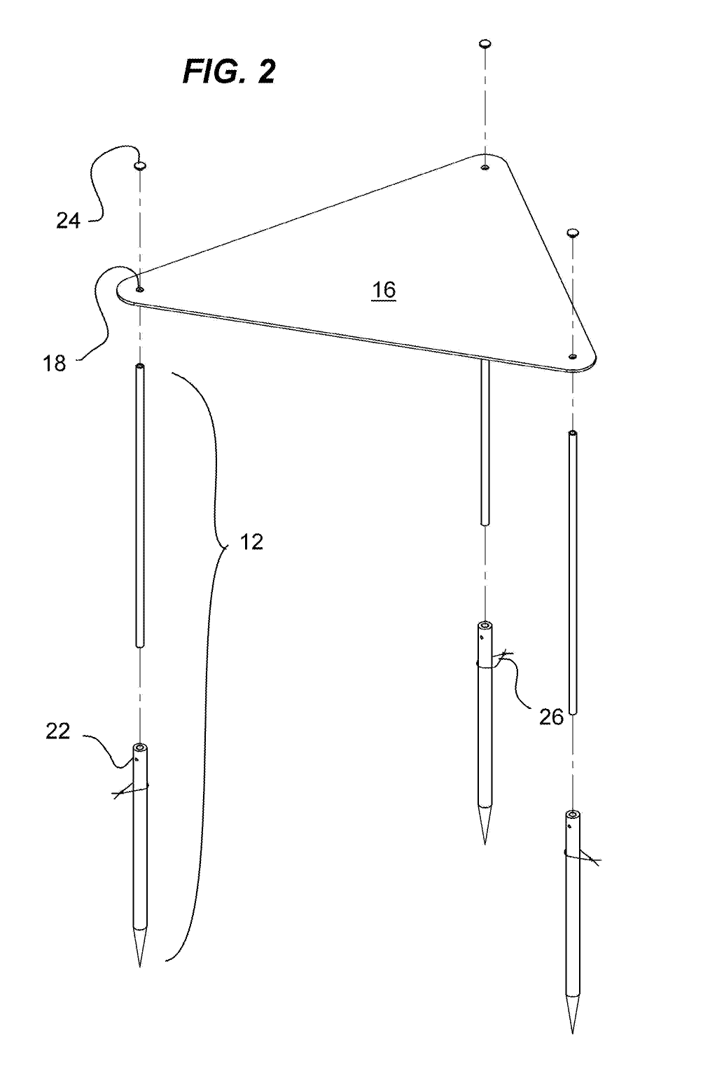

FIG. 3 Isometric view of the invention.

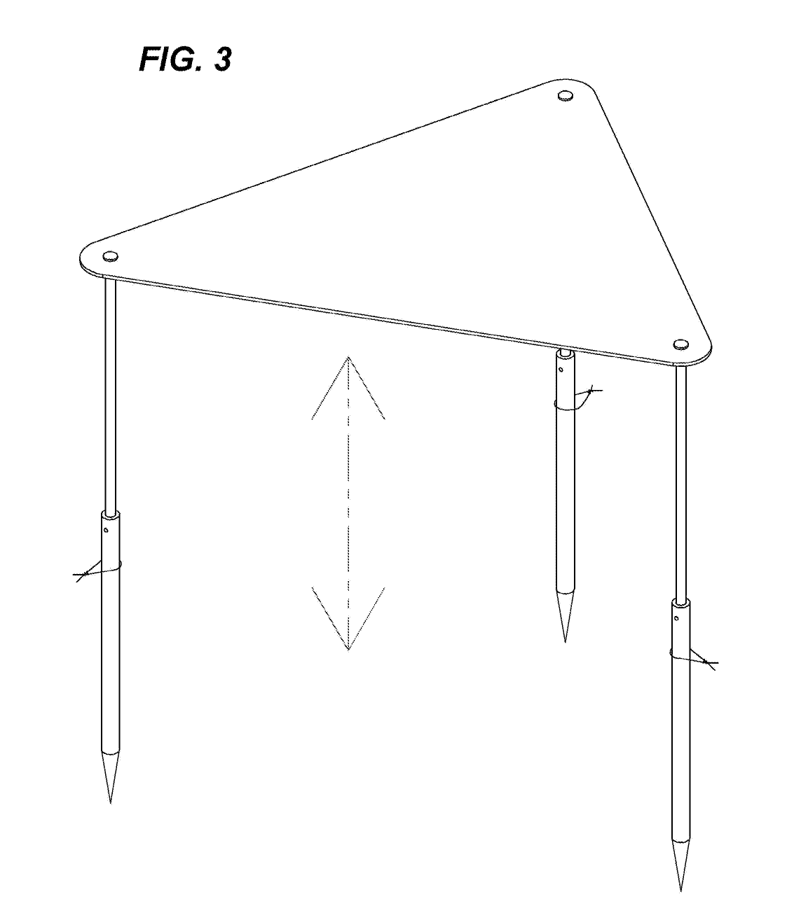

FIGS. 4a-b Side views of the invention showing the stakes protractans and retracted, respectively.

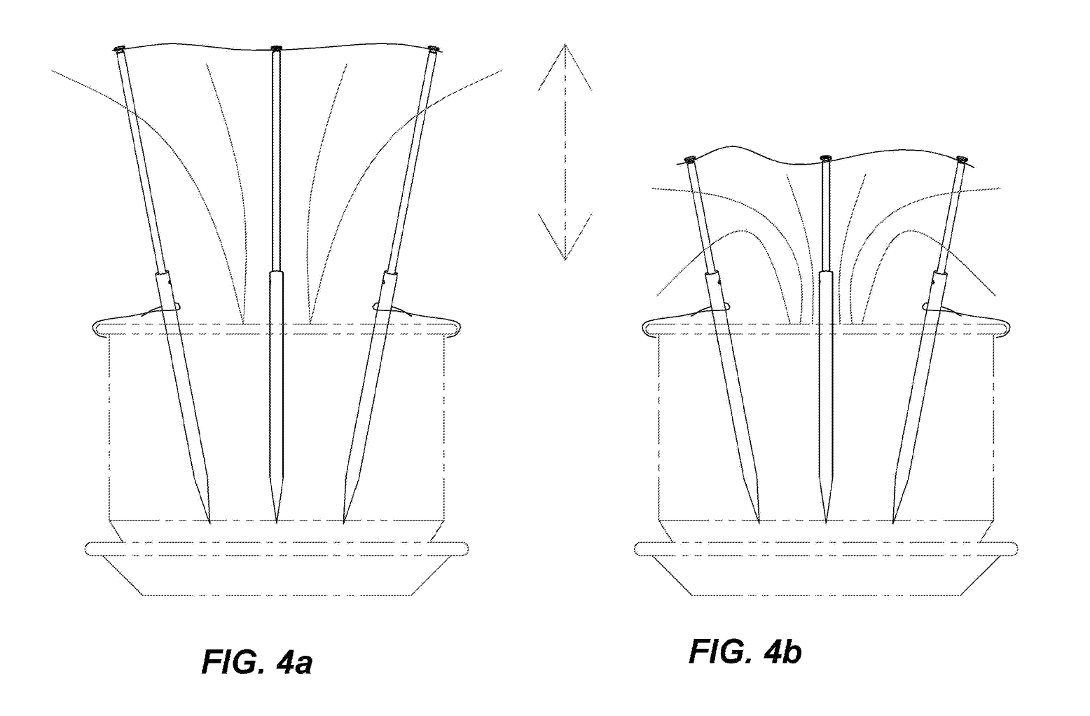

### DETAILED DESCRIPTION OF THE PREFERRED EMBODIMENT

A shading device for potted plants (10) has a plurality of stakes (12) planted in the soil of a flower pot (14). The stakes (12) can be telescoping in nature so as to be adjustable lengthwise. A piece of shading material preferably made of canvas (16) is stretched across the stakes (12) by way of grommets (18).

In order to use the invention a user plants the stakes (12) in the flower pot (14), adjusts their lengths according to the height of a plant (20) and hangs the canvas (16) onto the stakes (12) by using the grommets (18).

The length of the stakes (12) can be locked by means known in the art such as a tightening bolt (22) for example. To secure the canvas (16) over the stakes (12) snap fasteners (24) are used.

To further facilitate installation, the stakes (12) have one sharp extremity (13) that is planted in the soil of the pot (14) as is known in the art of stakes and a hollow opposite extremity (15) that is configured for receiving the snap fasteners (24) which pass through the grommets (18). The inner diameter of the grommet (18) is smaller than the outer diameter of the stake (12) so that the grommets (18) don't slide down the stakes (12).

Also, optionally, resiliently deformable strings (26) can be used to attach the stakes (12) to the flower pot (14).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, punch dies are the preferred tool used but other types of cutters such as rotary drill cutters could be used and still achieve a similar result.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1.) A shading device for potted plants comprising a plurality of hollow stake members adapted to be securely planted within soil of a potted plant, each said stake member having a pointed end portion adapted to pierce through said soil, and a hollow end portion opposite said pointed end portion; a piece of shading material having a plurality of grommets therein each adapted to receive a respective hollow end portion of respective stake members; and a plurality of pin members each adapted to extend through a respective grommet and into the hollow end portion of a respective stake member, such that said shading material is securely attached to said end portions of said plurality of stake members and adapted to be placed above a potted plant.

2.) The shading device of claim 1, wherein said snap fasteners have a top portion diameter that is larger than an inner diameter of said grommets, and a main portion diameter that is smaller than an inner diameter of said hollow end portions of said plurality of stake members, such that said pin members are adapted to be frictionally secured within the hollow end portion of each respective stake member, and releasably hold said shading material to each respective hollow end portion of each respective stake member.

3.) The shading device of claim 1, wherein each said plurality of stake members are formed from two telescoping portions, such that each of said plurality of stake members are adjustable in length; and wherein each said plurality of stake members includes a tightening bolt adapted to securely hold each respective telescoping portion in position to one another at respective desired lengths.

4.) The shading device of claim 1, wherein each said plurality of stake members each include an attachment member adapted to attach to a pot member of a potted plant, to thereby offer a secure position between said shade member and a potted plant.

5.) The shading device of claim 4, wherein each said attachment member is formed as a resilient string member.

6.) The shading device of claim 1, wherein said shading material is formed from a canvas material.

7.) The shading device of claim 1, wherein there are three stake members, and there are three grommets within said shading material.

8.) The shading device of claim 7, wherein said shading material is formed in the shape of a triangle.

9.) A combination of a potted plant and a shading device, comprising a plant that is potted within a pot member having soil therein; and a shading device comprising a plurality of hollow stake members adapted to be securely planted within said soil of said potted plant, each said stake member having a pointed end portion adapted to pierce through said soil, and a hollow end portion opposite said pointed end portion; a piece of shading material having a plurality of grommets therein each adapted to receive a respective hollow end portion of respective stake members; and a plurality of pin members each adapted to extend through a respective grommet and into the hollow end portion of a respective stake member, such that said shading material is securely attached to said end portions of said plurality of stake members and adapted to be placed above said potted plant.

10.) The shading device of claim 9, wherein said snap fasteners have a top portion diameter that is larger than an inner diameter of said grommets, and a main portion diameter that is smaller than an inner diameter of said hollow end portions of said plurality of stake members, such that said pin members are adapted to be frictionally secured within the hollow end portion of each respective stake member, and releasably hold said shading material to each respective hollow end portion of each respective stake member.

11.) The shading device of claim 9, wherein each said plurality of stake members are formed from two telescoping portions, such that each of said plurality of stake members are adjustable in length; and wherein each said plurality of stake members includes a tightening bolt adapted to securely hold each respective telescoping portion in position to one another at respective desired lengths.

12.) The shading device of claim 9, wherein each said plurality of stake members each include an attachment member adapted to attach to said pot member of said potted plant, to thereby offer a secure position between said shade member and said potted plant.

13.) The shading device of claim 12, wherein each said attachment member is formed as a resilient string member.

14.) The shading device of claim 9, wherein said shading material is formed from a canvas material.

15.) The shading device of claim 9, wherein there are three stake members, and there are three grommets within said shading material.

16.) The shading device of claim 14, wherein said shading material is formed in the shape of a triangle.
